(19) United States
(12) Patent Application Publication
(10) Pub. No.: US 2026/0200418 A1
(43) Pub. Date: Jul. 16, 2026

(54) WIRE HARNESS ROUTING STRUCTURE AND DOOR SUPPORT COMPONENT

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Daichi FUKUSHIMA, Osaka (JP); Satoshi YAMAMOTO, Osaka (JP); Tsubasa MARUYAMA, Osaka (JP); Koji ITO, Osaka (JP); Yoshinao KOBAYASHI, Osaka (JP); Hiroki UNO, Mie (JP); Kazuma ISODA, Mie (JP); Ryuya AOKI, Osaka (JP)

(21) Appl. No.: 19/136,890

(22) PCT Filed: Nov. 28, 2023
(86) PCT No.: PCT/JP2023/042547

§ 371 Date: Jun. 9, 2025

(30) Foreign Application Priority Data
Dec. 13, 2022 (JP) 2022-198354
Jul. 4, 2023 (JP) 2023-109837

(51) Int. Cl. B60R 16/027; B60J 5/06; B60R 16/02; H02G 3/30; H02G 11/00

(52) U.S. Cl. CPC B60R 16/027; B60J 5/06; B60R 16/0215; H02G 3/30; H02G 11/00

(57) ABSTRACT

A wire harness routing structure includes a wire harness and a door support component that supports a door-side section of the wire harness on a sliding door. The door support component includes a slider part provided in the door-side section and a guide component in which a guide groove for guiding the slider part is formed. The guide groove includes an opening/closing groove and a stress absorption groove. The slider part moves along the opening/closing groove when the sliding door is opened and closed. The slider part moves along the stress absorption groove when the sliding door is open and a tread load is applied to an exposed section of the wire harness.

### DESCRIPTION

### Technical Field

The present disclosure relates to a wire harness routing structure and a door support component.

### Background

Patent Document 1 discloses a routing structure of a wire harness for power supply that is applied to sliding doors of automobiles, and in which the wire harness for power supply is routed from the vehicle body side to the sliding door side. The routing structure moves a corrugated tube portion of the wire harness along the lower end of a door trim as the sliding door is opened and closed.

### PRIOR ART DOCUMENT

### Patent Document

Patent Document 1: JP 2015-074430 A

### SUMMARY OF THE INVENTION

### Problems to Be Solved

When the sliding door is open, a section of the wire harness between the sliding door and the vehicle body can be exposed and the exposed section can be stepped on.

Therefore, it is an object of the present invention to enable the prevention of high tension on a wire harness even when a tread load is applied to an exposed section of the wire harness between a sliding door and a vehicle body.

### Means to Solve the Problem

The wire harness routing structure according to the present disclosure relates to a wire harness routing structure that connects a device provided in a vehicle body and a device provided in a sliding door, the wire harness routing structure including: a wire harness that includes a vehicle body-side section supported on the vehicle body, a door-side section supported on the sliding door, and a free movement section located between the vehicle body-side section and the door-side section; and a door support component that supports the door-side section on the sliding door, wherein the free movement section includes an exposed section configured to be exposed between the vehicle body and the sliding door when the sliding door is open, the door support component includes a slider part provided in the door-side section and a guide component in which a guide groove for guiding the slider part is formed, the guide groove includes an opening/closing groove having a first end and a second end, and a stress absorption groove extending from the first end in a direction that intersects with an extending direction of the opening/closing groove, and when a state where the sliding door is closed is defined as a closed state, a state where the sliding door is open and no tread load is applied to the exposed section is defined as a first open state, and a state where the sliding door is open and a tread load is applied to the exposed section is defined as a second open state, the slider part is located at the first end of the opening/closing groove in the first open state, the opening/closing groove is formed so that the slider part moves along the opening/closing groove from the first end toward the second end during a change from the first open state to the closed state, and the stress absorption groove is formed so that the slider part moves along the stress absorption groove during a change from the first open state to the second open state.

### Effect of the Invention

According to the present disclosure, it is possible to prevent high tension from being applied to a wire harness even when a tread load is applied to an exposed section of the wire harness between a sliding door and a vehicle body.

### BRIEF DESCRIPTION OF THE DRAWINGS

FIG. 1 is a schematic plan view showing a wire harness routing structure according to Embodiment 1.

FIG. 2 is a schematic perspective view showing the wire harness routing structure according to Embodiment 1.

FIG. 3 is a schematic front view showing a first open state.

FIG. 4 is a cross-sectional view taken along a line IV-IV in FIG. 3.

FIG. 5 is a schematic front view showing a closed state.

FIG. 6 is a schematic front view showing a second open state.

FIG. 7 is a diagram illustrating tracks of slider parts.

FIG. 8 is a diagram showing a modification of a shaft-side protector and a bearing-side protector.

FIG. 9 is a schematic plan view showing a wire harness routing structure according to Embodiment 2.

FIG. 10 is a schematic front view showing a second open state.

FIG. 11 is a cross-sectional view taken along a line XI-XI in FIG. 10.

FIG. 12 is a schematic plan view showing a modification of the wire harness routing structure.

FIG. 13 is a cross-sectional view taken along a line XIII-XIII in FIG. 12.

### DETAILED DESCRIPTION TO EXECUTE THE INVENTION

### Description of Embodiments of Present Disclosure

Embodiments of the present disclosure will be first listed and described.

The wire harness routing structure according to the present disclosure are as follows.

(1) A wire harness routing structure that connects a device provided in a vehicle body and a device provided in a sliding door, the wire harness routing structure including: a wire harness that includes a vehicle body-side section supported on the vehicle body, a door-side section supported on the sliding door, and a free movement section located between the vehicle body-side section and the door-side section; and a door support component that supports the door-side section on the sliding door, wherein the free movement section includes an exposed section configured to be exposed between the vehicle body and the sliding door when the sliding door is open, the door support component includes a slider part provided in the door-side section and a guide component in which a guide groove for guiding the slider part is formed, the guide groove includes an opening/closing groove having a first end and a second end, and a stress absorption groove extending from the first end in a direction that intersects with an extending direction of the opening/closing groove, and when a state where the sliding door is closed is defined as a closed state, a state where the sliding door is open and no tread load is applied to the exposed section is defined as a first open state, and a state where the sliding door is open and a tread load is applied to the exposed section is defined as a second open state, the slider part is located at the first end of the opening/closing groove in the first open state, the opening/closing groove is formed so that the slider part moves along the opening/closing groove from the first end toward the second end during a change from the first open state to the closed state, and the stress absorption groove is formed so that the slider part moves along the stress absorption groove during a change from the first open state to the second open state.

According to the wire harness routing structure of the item (1), when a tread load is applied to the exposed section, the slider part moves along the stress absorption groove, thereby preventing the wire harness from being subjected to an excessive stress. With this, it is possible to avoid the application of high tension to the wire harness, even when a tread load is applied to the exposed section of the wire harness between the sliding door and the vehicle body.

(2) In the wire harness routing structure according to the item (1), the door support component may include a biasing part configured to bias the slider part toward the opening/closing groove along an extending direction of the stress absorption groove. With this, when the tread load is resolved, the slider part can return to the first end by the biasing force of the biasing part. Also, the biasing force of the biasing part can serve as a resistive force against the tread load.

(3) The wire harness routing structure according to the item (2) may further include: a vehicle body support component that supports the vehicle body-side section on the vehicle body at a position of the vehicle body-side section that is adjacent to the free movement section, wherein the biasing part may bias the slider part toward the first end along the extending direction of the opening/closing groove, and the first end may be further away from the vehicle body support component than the second end in the closed state. With this, in the closed state, it is easier for the portion of the free movement section that is continuous with the slider part to be hidden within the sliding door and harder to be exposed between the sliding door and the vehicle body.

(4) In the wire harness routing structure according to the item (3), the second end of the opening/closing groove may be located at a position lower than the first end in a vertical direction, an end of the stress absorption groove that is opposite to the first end may be located at a position lower than the first end in the vertical direction, and the biasing part may bias the slider part upward along the vertical direction. With this, the biasing part easily biases the slider part toward the first end both when the slider part moves along the first opening/closing groove and when the slider part moves along the first stress absorption groove. In addition, as a result of the slider part being biased toward the first end during the opening and closing of the sliding door, the free movement section is prevented from becoming slack.

(5) In the wire harness routing structure according to any one of the items (1) to (4), there may be only one set of the slider part and the guide groove along an extending direction of the door-side section. With this, it is possible to reduce the size of the guide component in the direction along the main surface of the sliding door, compared to the case in which the guide component has the plurality of guide grooves including the opening/closing groove and the stress absorption groove.

(6) In the wire harness routing structure according to the item (5), the slider part may include an inner slider part and an outer slider part that protrude from the same position along the extending direction of the door-side section to opposite sides of each other along an inside-outside direction of a vehicle, the guide component may include an inner guide plate provided on an interior side of the vehicle relative to the door-side section and an outer guide plate provided on an exterior side of the vehicle relative to the door-side section, and the guide groove may include an inner guide groove that is formed in the inner guide plate and into which the inner slider part is fitted, and an outer guide groove that is formed in the outer guide plate and into which the outer slider part is fitted. With this, it is easier to prevent the slider parts from disengaging from the guide grooves. It is also easier to realize the inner slider part and the outer slider part in a simple shape.

(7) In the wire harness routing structure according to the item (5) or (6), other than the slider part, there may be no slider part along the extending direction of the door-side section. With this, it is possible to reduce the complexity in the structure of the door support component.

(8) In the wire harness routing structure according to the item (5) or (6), the door support component may include a lower slider part provided below the slider part along the extending direction of the door-side section, and the lower slider part may be guided along the lower edge of the guide component between the first open state and the closed state. This allows the wire harness to be guided between the first open state and the closed state by the slider part and the lower slider part. Due to the absence of a guide groove corresponding to the lower slider part, it is possible to reduce the size of the guide component.

(9) In the wire harness routing structure according to any one of the items (1) to (8), the door support component may include a protector that covers and protects the door-side section, the slider part may be provided at an upper end of the protector, and a lower end of the protector may be a free end.

(10) In the wire harness routing structure according to any one of the items (1) to (4), the slider part may include a first slider part and a second slider part provided at positions distanced from each other along an extending direction of the door-side section, the guide groove may include a first guide groove configured to guide the first slider part and a second guide groove configured to guide the second slider part, the first guide groove may include a first opening/closing groove serving as the opening/closing groove and a first stress absorption groove serving as the stress absorption groove, and the second guide groove may include a second opening/closing groove serving as the opening/closing groove and a second stress absorption groove serving as the stress absorption groove. This allows the door-side section to be guided more smoothly by the opening and closing of the sliding door, thereby also allowing the free movement section continuous with the door-side section to change its posture more smoothly.

(11) In the wire harness routing structure according to the item (10), the first stress absorption groove and the second stress absorption groove may extend along one straight line. This allows the door-side section to be smoothly guided when a tread load is applied to the exposed section.

(12) In the wire harness routing structure according to the item (10) or (11), the first opening/closing groove may be shorter than the second opening/closing groove. With this, the sliding door does not need a large space for the guide component.

(13) In the wire harness routing structure according to any one of the items (10) to (12), the door support component may include a slider holding part that connects the first slider part and the second slider part to keep a distance between the first slider part and the second slider part constant. This allows the first slider part and the second slider part to move along the respective guide grooves while maintaining a constant distance therebetween.

(14) In the wire harness routing structure according to the item (13), the slider holding part may cover and protect the door-side section from a portion where the first slider part is provided to a portion where the second slider part is provided. With this, the slider holding part can be used as a protector for the wire harness.

(15) In the wire harness routing structure according to any one of the items (1) to (14), the sliding door may include a door body and an overhang that overhangs from a lower portion of the door body toward an interior side of a vehicle, the guide component may be located above the overhang and is mounted on the door body, the door support component may include a protector that covers and protects the door-side section, and the protector may include a first protective part that covers a portion of the door-side section where the slider part is provided, and a second protective part that extends from the first protective part to a lower and interior side of the vehicle. With this, while the guide component is fitted above the overhang of the sliding door, the lower portion of the door-side section is prevented by the second protective part from coming into contact with the overhang.

(16) In the wire harness routing structure according to any one of the items (1) to (15), the wire harness may include a wiring member and a corrugated tube that is externally fitted to the wiring member, and the wiring member may be inserted into the corrugated tube so as to be freely movable along an extending direction of the corrugated tube. Due to the fact that the corrugated tube is externally mounted on the wiring member, a tread load on the free movement section is transmitted to the wiring member via the corrugated tube. In this case, the wiring member can move freely in the extending direction with respect to the corrugated tube, and thus the wiring member easily follows the stretch deformation of the corrugated tube. Accordingly, it is possible to prevent an increase in tension applied to the wiring member even when a tread load is applied to the free movement section.

(17) In the wire harness routing structure according to the item (16), the door support component may include a protector that covers and protects a portion of the door-side section where the slider part is provided, and an end of the corrugated tube may be supported on the protector so as to be rotatable about a central axis. When the corrugated tube changes its posture due to the opening and closing of the sliding door, the corrugated tube can be subjected to a torque around the central axis. Even in this case, the torque applied to the corrugated tube can be absorbed by the rotation of the corrugated tube about the central axis with respect to the protector.

(18) Furthermore, the wire harness routing structure according to the present disclosure relates to a wire harness routing structure that connects a device provided in a vehicle body and a device provided in a sliding door, the wire harness routing structure including: a wire harness that includes a vehicle body-side section supported on the vehicle body, a door-side section supported on the sliding door, and a free movement section located between the vehicle body-side section and the door-side section; and a door support component that supports the door-side section on the sliding door, wherein the free movement section includes an exposed section configured to be exposed between the vehicle body and the sliding door when the sliding door is open, the door support component includes a slider part provided in the door-side section and a guide component in which a groove for guiding the slider part is formed, when a state where the sliding door is closed is defined as a closed state, and a state where the sliding door is open is defined as an open state, the slider part moves along the groove during a state change between the open state and the closed state, and there is only one set of the slider part and the groove along an extending direction of the door-side section. According to this configuration, it is possible to reduce the size of the guide component in the direction along the main surface of the sliding door.

(19) Furthermore, the door support component according to the present disclosure relates to a door support component for a wire harness that includes: a vehicle body-side section supported on a vehicle body, a door-side section supported on a sliding door, and a free movement section located between the vehicle body-side section and the door-side section, the door support component supporting the door-side section on the sliding door and including: a slider part provided in the door-side section; and a guide component in which a guide groove for guiding the slider part is formed, wherein the guide groove includes an opening/closing groove having a first end and a second end, and a stress absorption groove extending from the first end in a direction that intersects with an extending direction of the opening/closing groove, the free movement section includes an exposed section configured to be exposed between the vehicle body and the sliding door when the sliding door is open, and when a state where the sliding door is closed is defined as a closed state, a state where the sliding door is open and no tread load is applied to the exposed section is defined as a first open state, and a state where the sliding door is open and a tread load is applied to the exposed section is defined as a second open state, the first end of the opening/closing groove is located at a position where the slider part is located in the first open state, and the opening/closing groove is formed so that the slider part moves along the opening/closing groove from the first end toward the second end during a change from the first open state to the closed state, and the stress absorption groove is formed so that the slider part moves along the stress absorption groove during a change from the first open state to the second open state.

According to this door support component, when a tread load is applied to the exposed section, the slider part moves along the stress absorption groove, thereby preventing the wire harness from being subjected to excessive stress. Accordingly, it is possible to prevent high tension on the wire harness even when a tread load is applied to the exposed section of the wire harness between the sliding door and the vehicle body.

### Detail of Embodiments of Present Disclosure

The following will describe specific examples of a wire harness routing structure of the present disclosure with reference to the drawings. Note that the present disclosure is not limited to the examples, but is indicated by the claims, and is intended to include all modifications within the meaning and scope equivalent to the scope of the claims.

### Embodiment 1

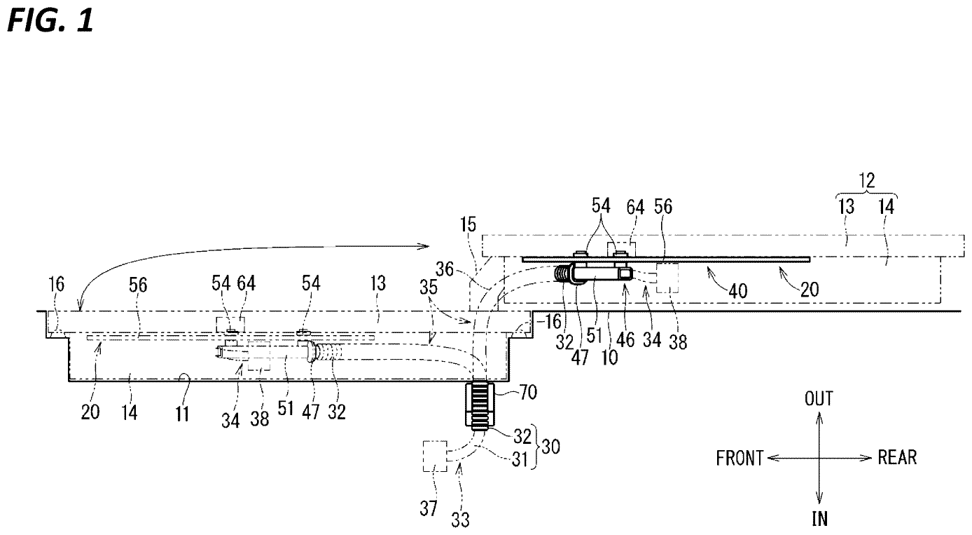

Hereinafter, a wire harness routing structure according to Embodiment 1 is described. FIG. 1 is a schematic plan view showing a wire harness routing structure 20 according to Embodiment 1. The front-back (FRONT, REAR) direction and the up-down (UP, LOW) direction shown in FIG. 1 correspond to the front-back direction and the up-down directions of a vehicle. The inside-outside direction (IN, OUT) shown in FIG. 1 corresponds to the inside-outside direction relative to a side of the vehicle in the left-right direction of the vehicle. Specifically, FIG. 1 shows the right side of the vehicle, and the left side of the right-side surface of the vehicle is a vehicle interior side, and the right side of the right-side surface of the vehicle is a vehicle exterior side.

First, the relationship between the wire harness routing structure 20, and a vehicle body 10 and a sliding door 12 to which the routing structure 20 is applied will be described. Note that, in FIG. 1, the wire harness routing structure 20 indicated by solid lines shows a state where the sliding door 12 is open, and the wire harness routing structure 20 indicated by dashed two-dotted lines shows a state where the sliding door 12 is closed. Also, in FIG. 1, some members including the sliding door 12 are shown in dashed two-dotted lines for both the open and closed states.

In the vehicle body 10, an entry/exit opening 11 for use when a passenger enters and exits the vehicle is provided on a side. The sliding door 12 is slidably supported on the vehicle body 10. The entry/exit opening 11 is opened and closed as a result of the sliding door 12 sliding. The sliding door 12 includes a door panel 13 that forms the exterior of the sliding door 12 and a door trim 14 provided on the vehicle interior side of the door panel 13. For example, a support arm 15 that supports the sliding door 12 is slidably supported on a support rail disposed on the vehicle body 10. At the peripheral edge of the entry/exit opening 11, a weather strip 16 is disposed so as to be in contact with the door panel 13 and the vehicle body 10. For example, the weather strip 16 is arranged in a ring shape on the outer peripheral side of the door trim 14 while the sliding door 12 is closed.

The sliding door 12 is provided with a door-side device such as a power window, for example. Such a door-side device is connected to a vehicle body-side device (such as an ECU, for example) installed in the vehicle body 10 via a wire harness 30. The wire harness 30 is routed across the vehicle body 10 and the sliding door 12. The wire harness routing structure 20 includes the wire harness 30 connecting the vehicle body-side device and the door-side device, a door support component 40 supporting the wire harness 30 on the sliding door 12, and a vehicle body support component 70 supporting the wire harness 30 on the vehicle body 10.

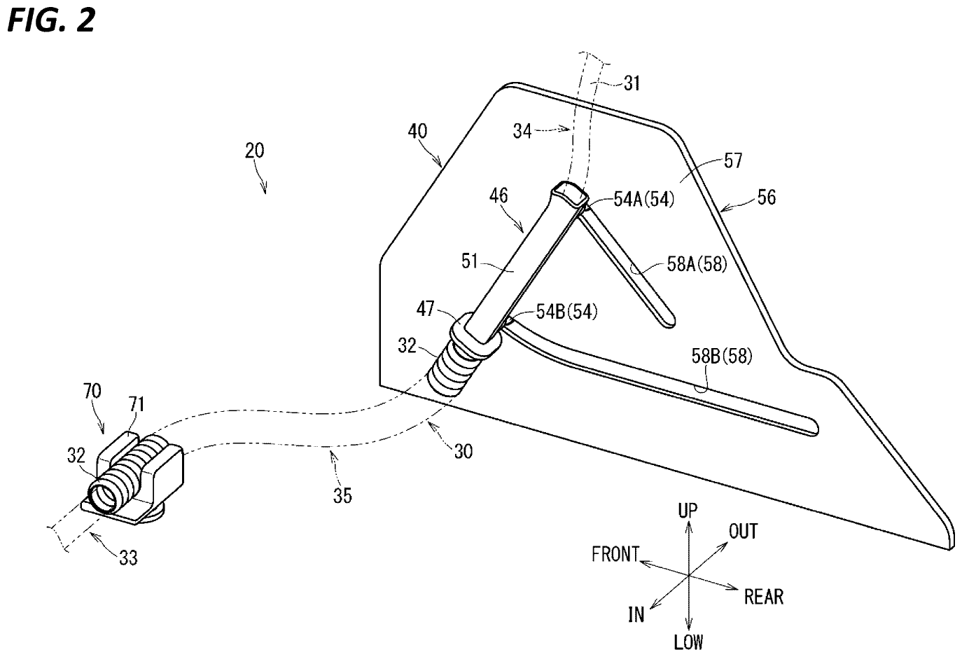

The wire harness 30 includes a wiring member 31 that transmits electric power or signals between the door-side device and the vehicle body-side device, and a corrugated tube 32 that is externally fitted to the wiring member 31. The wiring member 31 is, for example, an electrical wire or an optical fiber cable. The number of wiring members 31 may be one or more. The corrugated tube 32 protects the wiring member 31 or brings a plurality of wiring members 31 together. The corrugated tube 32 has a shape in which large-diameter and small-diameter tubular sections whose cross-section is circular are continuously alternated. The outer and inner surfaces of the corrugated tube 32 have a concave-convex shape in which concave and convex portions corresponding to the large-diameter and small-diameter tubular sections are continuous with each other along the extending direction of the corrugated tube 32. Note that, in FIG. 1, the ends of the corrugated tube 32 are shown in the shape that conforms to the original shape of the corrugated tube 32 with the concave-convex shape, whereas the intermediate part of the corrugated tube 32 is shown in a simplified form with the concave-convex shape omitted. The same applies in each of the figures from FIG. 2 onwards.

The wire harness 30 includes a vehicle body-side section 33 supported on the vehicle body 10, a door-side section 34 supported on the door, and a free movement section 35 located between the vehicle body-side section 33 and the door-side section 34. The vehicle body-side section 33, the door-side section 34, and the free movement section 35 are different sections located along the extending direction of the wire harness 30.

The vehicle body-side section 33 is supported on the vehicle body 10 by the vehicle body support component 70. The vehicle body-side section 33 is held on the vehicle body 10 when the sliding door 12 is opened and closed. The vehicle body-side section 33 is positioned above the floor panel, for example, and is covered by a floor carpet or floor mat so as not to be exposed. For example, the vehicle body 10 has, in the vicinity of the entry/exit opening 11, a vehicle body-side harness opening through which the wire harness 30 is led out. The vehicle body support component 70 shown in FIG. 1 supports the portion of the vehicle body-side section 33 that is continuous with the free movement section 35 in the vicinity of the vehicle body-side harness opening. The free movement section 35 extends out of the vehicle body 10 through the vehicle body-side harness opening.

The door-side section 34 is a section that is supported on the sliding door 12 by the door support component 40. The door-side section 34 is held by the sliding door 12 and is moved together with the sliding door 12 with respect to the vehicle body 10 when the sliding door 12 is opened and closed. Here, part of the door-side section 34 is supported by the door support component 40 so as to move along a certain path with respect to the sliding door 12 when the sliding door 12 is opened and closed. The door-side section 34 is disposed between the door panel 13 and the door trim 14 so as not to be exposed. The door trim 14 has a door-side harness opening through which the wire harness 30 is led out. The door-side harness opening is provided, for example, below the door trim 14. The free movement section 35 extends out of the sliding door 12 through the door-side harness opening.

The free movement section 35 is not supported on the vehicle body 10 and the sliding door 12, and can move freely with respect to the vehicle body 10 and the sliding door 12 in contrast to the vehicle body-side section 33 and the door-side section 34. When the sliding door 12 is opened and closed, the free movement section 35 moves and changes its posture with respect to the vehicle body 10 and sliding door 12 by being pulled by the sliding door 12. The corrugated tube 32 is provided in the free movement section 35. Here, the free movement section 35 is assumed to move in three dimensions when the sliding door 12 is opened and closed, and the corrugated tube 32 can follow the three-dimensional movement of the free movement section 35. One end of the corrugated tube 32 extends to the vehicle body-side section 33 and is supported on the vehicle body 10 by the vehicle body support component 70. The other end of the corrugated tube 32 extends to the door-side section 34 and is supported on the sliding door 12 by the door support component 40.

The free movement section 35 includes an exposed section 36. The exposed section 36 is a section that is exposed between the vehicle body 10 and the sliding door 12 when the sliding door 12 is open. Here, the corrugated tube 32 provided in the free movement section 35 is exposed. For example, the exposed section 36 is a portion of the free movement section 35 between the vehicle body-side harness opening and the door-side harness opening.

The exposed section 36 is exposed to the entry/exit opening 11 at a position at which it is as unlikely as possible to interfere with a passenger who is getting in or out of the vehicle, such as a rear and lower position of the vehicle. However, since the exposed section 36 is exposed to the entry/exit opening 11, it is difficult to completely eliminate the situation that the exposed section 36 is stepped on by a passenger who is getting in or out through the entry/exit opening 11. In addition, since the corrugated tube 32 provided in the free movement section 35 is easily stretched and deformed, it is difficult to support a tread load only with the corrugated tube 32. Here, when a tread load is applied to the exposed section 36, high tension on the exposed section 36 is prevented.

In the following, the state where the sliding door 12 is closed is referred to as a “closed state”. The state where the sliding door 12 is open and no tread load is applied to the exposed section 36 is referred to as a “first open state”. The first open state is a state where the free movement section 35 is in a natural state thereof. The state where the sliding door 12 is open and a tread load F is applied to the exposed section 36 is referred to as a “second open state”.

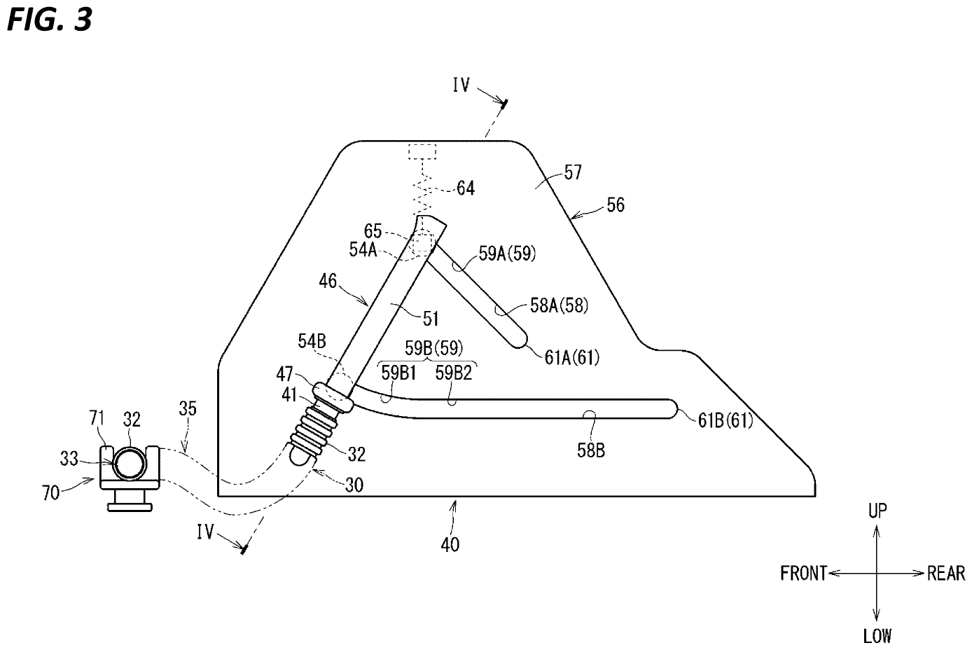

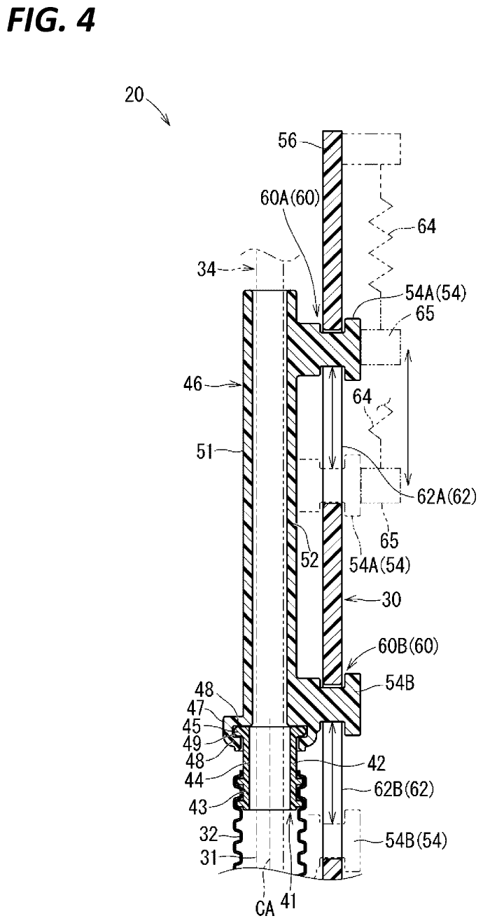

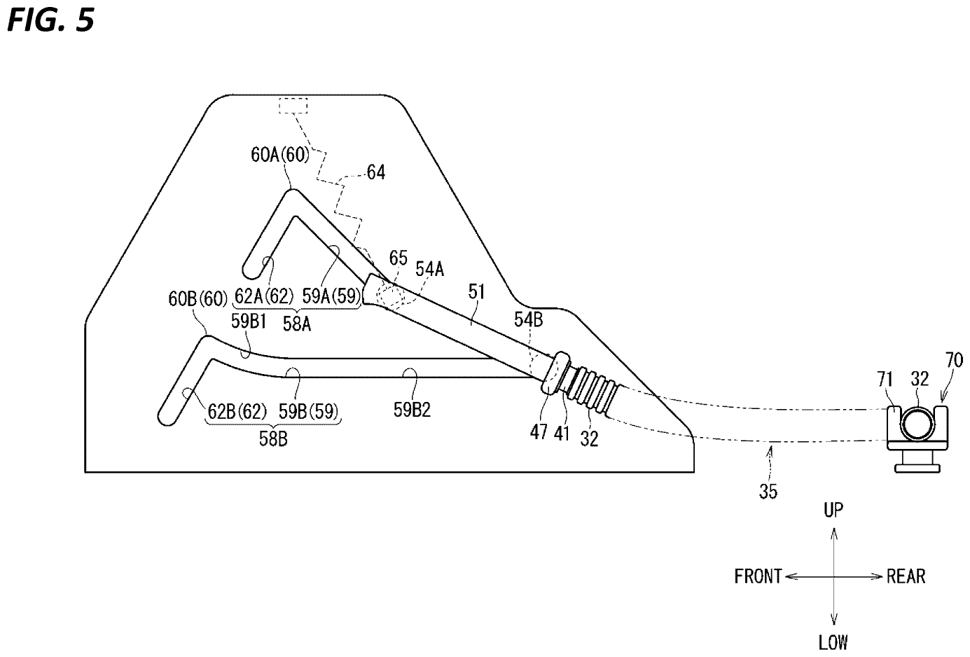

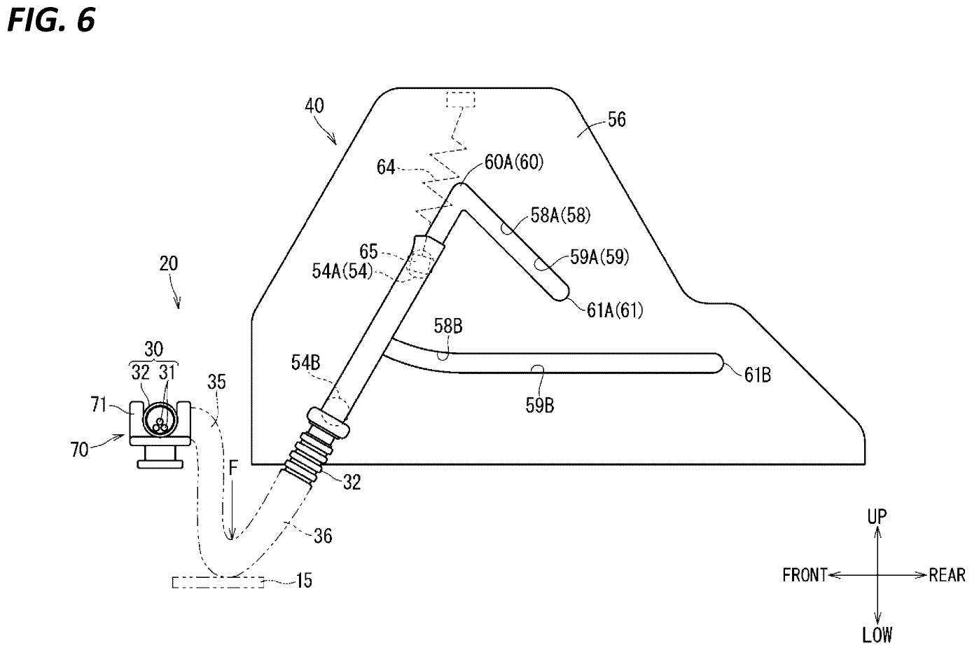

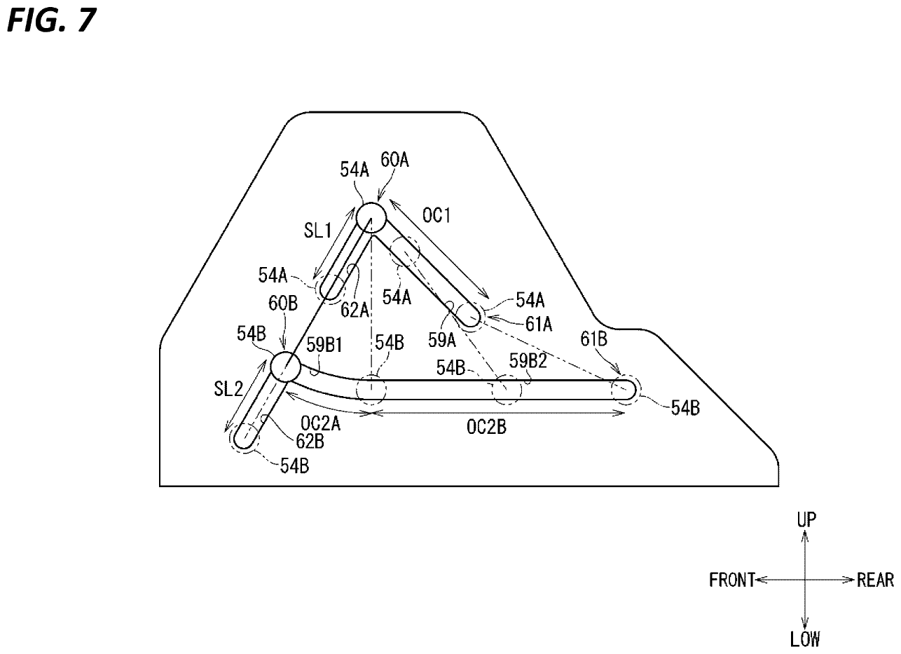

Constituent components of the wire harness routing structure 20 will be described more specifically. FIG. 2 is a schematic perspective view showing the wire harness routing structure 20. FIG. 3 is a schematic front view showing the first open state. FIG. 4 is a cross-sectional view taken along a line IV-IV in FIG. 3. FIG. 5 is a schematic front view showing the closed state. FIG. 6 is a schematic front view showing the second open state. FIG. 7 is a diagram illustrating tracks of slider parts 54.

In the wire harness 30, the wiring member 31 is inserted into the corrugated tube 32 so as to be freely movable along the extending direction thereof. This makes the wiring member 31 less susceptible to external forces applied to the corrugated tube 32. Specifically, the wiring member 31 is only passed through the corrugated tube 32 and is not fixed to the corrugated tube 32. Therefore, even if the corrugated tube 32 is twisted, the wire harness 30 is not easily twisted. Also, the corrugated tube 32 can undergo stretch deformation and is elongated, as a result of, when the intermediate part is pushed in a direction that intersects with the axial direction, the intermediate part bending so as to be pulled in the direction in which it is pushed and the differences between the concave-convex parts becoming smaller. In this case, when the wiring member 31 is pushed against the corrugated tube 32, the corrugated tube 32 freely moving along the extending direction prevents an increase in tension on the wiring member 31.

The door support component 40 includes a shaft-side protector 41, a bearing-side protector 46, a guide component 56, and a biasing part 64.

The shaft-side protector 41 includes a tubular body 42, a tube holding part 43, and a shaft part 44. The shaft-side protector 41 is made of resin or metal. The rigidity of the shaft-side protector 41 is higher than the rigidity of the corrugated tube 32. The tubular body 42 is cylindrical. The tube holding part 43 is provided at one end of the tubular body 42 in the axial direction thereof and the shaft part 44 is provided at the other end of the tubular body 42.

The tube holding part 43 holds the corrugated tube 32. Here, an end of the corrugated tube 32 covers the tube holding part 43. The tube holding part 43 has annular protrusions protruding from the outer circumference of the tubular body 42. As a result of the annular protrusions being fitted into the large-diameter tubular sections of the corrugated tube 32, the corrugated tube 32 is held in the tube holding part 43.

The shaft part 44 is a part supported by the bearing-side protector 46. The shaft part 44 has a flange 45. The flange 45 protrudes from the outer circumference of the tubular body 42 at the other end of the tubular body 42 in the axial direction thereof. The flange 45 protrudes from the outer circumference of the tubular body 42 to a greater extent than the annular protrusions.

The bearing-side protector 46 includes a bearing part 47, a protective part 51, and a slider part 54. The bearing-side protector 46 is made of resin or metal. The rigidity of the bearing-side protector 46 is higher than the rigidity of the corrugated tube 32.

The bearing part 47 supports the shaft part 44 so that it is rotatable. Each of the bearing part 47 and the shaft part 44 has a cylindrical circumferential surface around a central axis CA. Here, the shaft part 44 has a cylindrical outer circumferential surface and the bearing part 47 has a cylindrical inner circumferential surface. Here, the bearing part 47 has a pair of confining walls 48. The pair of confining walls 48 are located on both sides of the flange 45 with respect to the direction of the central axis CA. A space between the pair of confining walls 48 is defined as an annular recess 49 into which the flange 45 is fitted. The portion of the shaft-side protector 41 that includes the tube holding part 43 extends from the bearing part 47 to the outside of the bearing-side protector 46. An insertion hole 50 corresponding to the tubular body 42 is formed in the center of one of the pair of confining walls 48. An insertion hole 50 corresponding to the wiring member 31 is formed in the center of the other of the pair of confining walls 48.

The end of the corrugated tube 32 is supported on the bearing-side protector 46 via the shaft-side protector 41 so as to be rotatable about the central axis CA. The corrugated tube 32 rotates as one piece with the shaft-side protector 41 about the central axis CA with respect to the bearing-side protector 46. In this case, the corrugated tube 32 need not rotate at all about the central axis CA with respect to the shaft-side protector 41, or may rotate to some extent. The shaft-side protector 41 is more likely to rotate with respect to the bearing-side protector 46 than the corrugated tube 32.

The circular shape of the corrugated tube 32 can be distorted by torque. Accordingly, when the torque directly rotate the corrugated tube 32 about the central axis CA with respect to the bearing-side protector 46, there is a risk that the corrugated tube 32 cannot rotate smoothly. Here, the shaft-side protector 41 attached to the corrugated tube 32 rotates about the central axis CA with respect to the bearing-side protector 46, so that the corrugated tube 32 can rotate more smoothly than when it is rotated directly with respect to the bearing-side protector 46.

Since the bearing-side protector 46 supports the shaft-side protector 41 so that the shaft-side protector 41 can substantially rotate only about the central axis CA, the space required for a support component for the movable body is reduced compared to a case where a spherical part is used. Note that the shaft-side protector 41 may be rotatable with respect to the bearing-side protector 46 to some extent in a manner other than about the central axis CA, due to tolerances and play between the shaft part 44 and the bearing part 47.

The protective part 51 is continuous with the bearing part 47. The protective part 51 covers the portion of the wire harness 30 that protrudes from the bearing part 47. The protective part 51 has a protective wall 52 that covers at least a portion of the wire harness 30 along the circumferential direction. Here, the protective part 51 is tubular so that the protective wall 52 covers the entire circumference of the wire harness 30. The protective part 51 may be cylindrical or square tubular. The protective wall 52 protrudes from the circumferential edge of the insertion hole 50 formed in the center of the other of the pair of confining walls 48.

The wiring member 31 is passed through the shaft-side protector 41 and the bearing-side protector 46. The wiring member 31 may also be inserted into the shaft-side protector 41 and the bearing-side protector 46 so as to be freely movable along the extending direction thereof. This makes the wiring member 31 less susceptible to external forces applied to the shaft-side protector 41 and the bearing-side protector 46.

The slider part 54 is provided in the door-side section 34. The slider part 54 protrudes from the outer surface of the protective wall 52. The slider part 54 has a columnar portion protruding from the outer surface of the protective wall 52. A circumferential groove is formed in the outer surface of the columnar portion. The slider part 54 and the protective wall 52 may be molded in one piece using a mold, or a slider part 54 molded separately from the protective wall 52 may be retrofitted to the protective wall 52.

A first slider part 54A and a second slider part 54B are provided as the slider part 54. The first slider part 54A and the second slider part 54B are connected to each other by a slider holding part with the distance between the first slider part 54A and the second slider part 54B kept constant. Here, this can be regarded as the slider holding part. The first slider part 54A and the second slider part 54B are distanced from each other on the outer surface of the protective wall 52 along the extending direction of the door-side section 34. Accordingly, the protective wall 52 can be regarded as the slider holding part. The protective wall 52 serving as the slider holding part covers and protects the door-side section 34 from the portion where the first slider part 54A is provided to the portion where the second slider part 54B is provided. The protective wall 52 extends straight between the portion where the first slider part 54A is provided and the portion where the second slider part 54B is provided. The protective part 51 may extend while bending from the portion where the first slider part 54A is provided to the portion where the second slider part 54B is provided.

A guide groove 58 that guides the slider part 54 is formed in the guide component 56. The guide component 56 includes a plate-shaped guide body 57 that extends along the door panel 13. The guide groove 58 is formed in the guide body 57. The slider part 54 moves along the guide groove 58 in the guide component 56. The inner peripheral edge of the guide groove 58 is fitted into the circumferential groove of the slider part 54. The guide groove 58 has an opening/closing groove 59 and a stress absorption groove 62.

The opening/closing groove 59 has a first end 60 and a second end 61. The slider part 54 is located at the first end 60 of the opening/closing groove 59 in the first open state. The opening/closing groove 59 is designed so that the slider part 54 moves in the opening/closing groove 59 from the first end 60 toward the second end 61 during the change from the first open state to the closed state. The first end 60 is located on the front side of the vehicle relative to the second end 61. In the open state, the second end 61 is further away from the vehicle body support component 70 than the first end 60. In the closed state, the first end 60 is further away from the vehicle body support component 70 than the second end 61. In the opening/closing groove 59, the second end 61 is located at a lower position than the first end 60 in the vertical direction.

The stress absorption groove 62 extends from the first end 60 in a direction that intersects with the extending direction of the opening/closing groove 59. The stress absorption groove 62 is provided so that the slider part 54 moves along the stress absorption groove 62 during the change from the first open state to the second open state. In the stress absorption groove 62, the end opposite to the first end 60 is located at a lower position in the vertical direction than the first end 60. The stress absorption groove 62 extends from the first end 60 to the front and bottom of the vehicle. The stress absorption groove 62 is shorter than the opening/closing groove 59.

The guide groove 58 has a first guide groove 58A that guides the first slider part 54A and a second guide groove 58B that guides the second slider part 54B. The first guide groove 58A has a first opening/closing groove 59A serving as the opening/closing groove 59 and a first stress absorption groove 62A serving as the stress absorption groove 62. The second guide groove 58B has a second opening/closing groove 59B serving as the opening/closing groove 59 and a second stress absorption groove 62B serving as the stress absorption groove 62. The first guide groove 58A is located above the second guide groove 58B.

The first opening/closing groove 59A has a first end 60A and a second end 61A. Here, the first opening/closing groove 59A consists only of a straight portion. The first opening/closing groove 59A extends straight from the first end 60A toward the second end 61B to the rear and bottom of the vehicle. The first opening/closing groove 59A is shorter than the second opening/closing groove 59B.

The second opening/closing groove 59B has a first end 60B and a second end 61B. The second opening/closing groove 59B includes a curved portion 59B1. The second opening/closing groove 59B consists of a combination of the curved portion 59B1 and a straight portion 59B2. The curved portion 59B1 is a portion of the second opening/closing groove 59B on the first end 60B side and the straight portion 59B2 is a portion of the second opening/closing groove 59B on the second end 61B side. One end of the curved portion 59B1 is the first end 60B, one end of the straight portion 59B2 is the second end 61B, and the other end of the curved portion 59B1 is continuous with the other end of the straight portion 59B2.

The curved portion 59B1 extends in a shape of an arc centered at the first end 60A. Here, the curved portion 59B1 is shorter than a quarter arc (arc of a quadrant). The curved portion 59B1 may be longer than a quarter arc. The straight portion 59B2 extends from the other end of the curved portion 59B1 in the direction of tangent of the other end of the curved portion 59B1. The straight portion 59B2 is longer than both of the curved portion 59B1 and the first opening/closing groove 59A. The direction in which the straight portion 59B2 extends and the direction in which the first opening/closing groove 59A extends intersect with each other. The first opening/closing groove 59A is inclined more largely with respect to the horizontal direction than the straight portion 59B2. The straight portion 59B2 extends from the first end 60 toward the rear of the vehicle straight and parallel to the horizontal direction. A connection portion between the curved portion 59B1 and the straight portion 59B2 is located directly below the first end 60A. The curved portion 59B1 extends from the connection portion between the curved portion 59B1 and the straight portion 59B2 to the front of the vehicle relative to the first end 60A. The straight portion 59B2 extends from the connection portion between the curved portion 59B1 and the straight portion 59B2 to the rear of the vehicle relative to the first end 60A. The first end 60B is located on the front side of the vehicle relative to the first end 60A, and the second end 61B is located on the rear side of the vehicle relative to the first end 60A.

The first stress absorption groove 62A and the second stress absorption groove 62B extend along one straight line. The second stress absorption groove 62B is located on a virtual extension line obtained by virtually extending the first stress absorption groove 62A to the bottom of the vehicle. The length of the first stress absorption groove 62A and the length of the second stress absorption groove 62B are equal to each other.

Since the first slider part 54A and the second slider part 54B are held at a fixed distance by the protective wall 52, the first slider part 54A and the second slider part 54B coordinate with each other at a fixed distance, as shown in FIG. 7. This distance is the distance between the first end 60A and the first end 60B. In the first open state, the first slider part 54A is located at the first end 60A and the second slider part 54B is located at the first end 60B. The distance between the second end 61A and the second end 61B is also equal to the distance between the first end 60A and the first end 60B.

The position of the first slider part 54A and the position of the second slider part 54B determine the posture of the bearing-side protector 46, and the posture of the bearing-side protector 46 determines the postures of the ends of the shaft-side protector 41 and the corrugated tube 32. The bearing-side protector 46 extends in a direction connecting the position of the first slider part 54A and the position of the second slider part 54B. The end of the corrugated tube 32 supported by the bearing-side protector 46 via the shaft-side protector 41 extends in the direction in which the bearing-side protector 46 extends.

The biasing part 64 biases the slider part 54 toward the opening/closing groove 59 along the extending direction of the stress absorption groove 62. Here, the biasing part 64 biases the slider part 54 toward the first end 60 along the extending direction of the opening/closing groove 59. The biasing part 64 biases the slider part 54 in a direction between the extending direction of the opening/closing groove 59 and the extending direction of the stress absorption groove 62. The biasing part 64 may be, for example, a spring such as a coil spring, a spiral spring, or a constant load spring. The slider part 54 is provided with a biasing part support part 65 that supports one end of the biasing part 64. The other end of the biasing part 64 is supported by, for example, the guide body 57 or the like.

Here, the biasing part 64 is coupled to the first slider part 54A. The biasing part 64 biases the first slider part 54A upward along the vertical direction. With this, the first slider part 54A is biased toward the first opening/closing groove 59A along the extending direction of the first stress absorption groove 62A and is biased toward the first end 60 along the extending direction of the first opening/closing groove 59A.

The vehicle body support component 70 supports the vehicle body-side section 33 to the vehicle body 10 at a location adjacent to the free movement section 35 of the vehicle body-side section 33. The vehicle body support component 70 has a tube holding part 71. The tube holding part 71 supports the corrugated tube 32 at a fixed position along the extending direction thereof. The tube holding part 71 may support the corrugated tube 32 so that it is rotatable about the central axis CA or non-rotatable. The vehicle body support component 70 is attached to the vehicle body 10 at a fixed position. With this, the end of the corrugated tube 32 on the vehicle body 10 side is held on the vehicle body 10 at a fixed position. The vehicle body support component 70 is supported on the vehicle body 10 so as to be non-rotatable. With this, the orientation in which the end of the corrugated tube 32 on the vehicle body 10 side extends from the vehicle body support component 70 is kept constant. The vehicle body support component 70 may be supported on the vehicle body 10 so as to allow a pivoting movement to change the orientation in which the end of the corrugated tube 32 extends outward.

At each of the one end and the other end of the corrugated tube 32, the large-diameter and small-diameter tube sections of several cycles are held by the corresponding tube holding part 43 or 71. Therefore, at each of the one end and the other end of the corrugated tube 32, the corrugated tube 32 is prevented from bending by the corresponding tube holding part 43 or 71.

A vehicle body-side connector 37 at one end of the wiring member 31 is positioned and fixed to the vehicle body 10 by being connected to a vehicle body-side device. The tube holding part 71 of the vehicle body support component 70 positions and fixes the corrugated tube 32 along the extending direction. The wiring member 31 is not fixed to the corrugated tube 32 and thus is not positioned and fixed to the tube holding part 71. A fixing portion may also be provided between the vehicle body-side connector 37 and the tube holding part 71 to position and fix the wiring member 31 to the vehicle body 10.

A door-side connector 38 at the other end of the wiring member 31 is positioned and fixed to the sliding door 12 by being connected to a door-side device. The portion of the wiring member 31 that is passed through the shaft-side protectors 41 and the bearing-side protector 46 is freely movable with respect to the protectors 41 and 46 and moves with respect to the sliding door 12, so the portion of the wiring member 31 is not positioned and fixed to the sliding door 12. A fixing portion may also be provided between the door-side connector 38 and the bearing-side protector 46 to position and fix the wiring member 31 to the sliding door 12.

### <Regarding Operation of Slider Part and Deformation of Free Movement Section>

The following will describe the operation of the slider part 54 and the deformation of the free movement section 35 in detail.

When the state is changed between the first open state and the closed state due to the opening and closing operation of the sliding door 12, the first slider part 54A moves along the first opening/closing groove 59A and the second slider part 54B moves along the second opening/closing groove 59B. When the second slider part 54B moves in the curved portion 59B1 from the first end 60B to the second end 61B, the first slider part 54A remains at the first end 60A until the second slider part 54B reaches the straight portion 59B2. When the second slider part 54B moves in the straight portion 59B2, the first slider part 54A moves in the first opening/closing groove 59A. More specifically, in FIG. 7, when the second slider part 54B moves in the curved portion 59B1 along the orientation of an arrow OC2A, the first slider part 54A remains at the first end 60A and rotates. In FIG. 7, when the second slider part 54B moves in the straight portion 59B2 along the orientation of an arrow OC2B, the first slider part 54A moves in the first opening/closing groove 59A along the orientation of an arrow OC1. In this case, the rotation movement is also added, so the distance that the first slider part 54A travels along the first opening/closing groove 59A is shorter than the distance that the second slider part 54B travels along the straight portion 59B2.

In the first open state, most of the sliding door 12 is located on the rear side of the vehicle relative to the entry/exit opening 11, and accordingly, the shaft-side protector 41 is located on the rear side of the vehicle relative to the vehicle body support component 70. The bearing-side protector 46 extends in a direction connecting the first end 60A and the first end 60B, and the corrugated tube 32 extends from the shaft-side protector 41 to the front and bottom of the vehicle.

In the closed state, the sliding door 12 closes the entry/exit opening 11, and accordingly, the shaft-side protector 41 is positioned on the front side of the vehicle relative to the vehicle body support component 70. At this time, the bearing-side protector 46 extends in a direction connecting the first slider part 54A located in the vicinity of the second end 61A and the second slider part 54B located in the vicinity of the second end 61B, and the corrugated tube 32 extends out of the shaft-side protector 41 to the rear and bottom of the vehicle.

In the closed state, the first slider part 54A and the second slider part 54B are located in the respective straight grooves. This makes it easier for the first slider part 54A and the second slider part 54B to move toward the first end 60A and the first end 60B when the first slider part 54A is biased to the first end 60A in the closed state. Here, in the closed state, the free movement section 35 can become slack. Even in this case, as a result of the first slider part 54A and the second slider part 54B moving toward the first end 60A and the first end 60B, the free movement section 35 is likely to be in an appropriately tensioned state and the free movement section 35 is not likely to become slack. With this, the portion of the free movement section 35 that extends out of the door trim 14 is not likely to be exposed to the interior space of the vehicle in the closed state.

When the state is changed between the first open state and the second open state by the exposed section 36 being subjected to a tread load F or the tread load F being released, the first slider part 54A moves along the first stress absorption groove 62A and the second slider part 54B moves along the second stress absorption groove 62B. The distance that the first slider part 54A travels along the first stress absorption groove 62A is equal to the distance that the second slider part 54B travels along the second stress absorption groove 62B. More specifically, in FIG. 7, when the second slider part 54B moves along the second stress absorption groove 62B in the orientation of an arrow SL2, the first slider part 54A moves along the first stress absorption groove 62A in the orientation of an arrow SL1.

For example, the exposed section 36 is located above a rigid component of the vehicle (such as the support arm 15 or a step portion of the vehicle). For example, the length of the stress absorption groove 62 may be set so as to allow the exposed section 36 subjected to the tread load F to move to the rigid component. After the exposed section 36 subjected to the tread load F reaches the rigid component, the rigid component supports the exposed section 36 from below, making it difficult for the tread load F to act as tension on the wire harness 30. The presence of the rigid component prevents the exposed section 36 subjected to the tread load F from moving below the step.

The length of the stress absorption groove 62 may also take into account the stretch deformation of the corrugated tube 32 that is externally fitted to the exposed section 36. The length of the stress absorption groove 62 can be shortened by the stretch deformation of the corrugated tube 32.

In the second open state, the first slider part 54A and the second slider part 54B are located in the respective straight grooves. This makes it easier for the first slider part 54A and the second slider part 54B to move toward the first end 60A and the first end 60B when the tread load F is resolved and the first slider part 54A is biased to the first end 60A in the second open state. Therefore, upon the tread load F being resolved, the first slider part 54A and the second slider part 54B are likely to return to the first end 60A and the first end 60B by the biasing force of the biasing part 64.

The angle between the extending direction of the first stress absorption groove 62A and the vertical direction is smaller than the angle between the extending direction of the first opening/closing groove 59A and the vertical direction. Therefore, when the first slider part 54A travels the same distance from the first end 60 along the first stress absorption groove 62A and the first opening/closing groove 59A, the biasing force of the biasing part 64 is greater when the first slider part 54A travels along the first stress absorption groove 62A.

The wiring member 31 is not fixed to the corrugated tube 32 and the protectors 41 and 46, and is freely movable with respect to the corrugated tube 32 and the protectors 41 and 46 along the extending direction. During the above-described state change, the corrugated tube 32 and the protectors 41 and 46 first change their postures, and the wiring member 31 is pushed by the corrugated tube 32 and the protectors 41 and 46 to change the postures to follow the corrugated tube 32 and the protectors 41 and 46. In this case, the portion of the wiring member 31 that is pushed by the corrugated tube 32 and the protectors 41 and 46 changes as appropriate. Even in this case, as a result of the wiring member 31 moving freely in the extending direction with respect to the corrugated tube 32 and the protectors 41 and 46, it is possible to avoid the application of excessively high tension to the portion of the wiring member 31 that is pushed by the corrugated tube 32 and the protectors 41 and 46.

### <Effects>

According to the door support component 40 and the wire harness routing structure 20 provided with the door support component 40 that have the above-described configurations, when a tread load F is applied to the exposed section 36, the slider part 54 moves along the stress absorption groove 62, thereby preventing the wire harness 30 from being subjected to excessive stress. Accordingly, it is possible to prevent high tension on the wire harness 30 even when a tread load F is applied to the exposed section 36 of the wire harness 30 between the sliding door 12 and the vehicle body 10.

Also, the door support component 40 includes the biasing part 64 that biases the slider part 54 toward the opening/closing groove 59 along the extending direction of the stress absorption groove 62. With this, when the tread load F is resolved, the slider part 54 can return to the first end 60 by the biasing force of the biasing part 64. The biasing force of the biasing part 64 can serve as a resistive force against the tread load F.

Also, the biasing part 64 biases the slider part 54 toward the first end 60 along the extending direction of the opening/closing groove 59, and in the closed state, the first end 60 is further away from the vehicle body support component 70 than the second end 61. With this, in the closed state, it is easier for the portion of the free movement section 35 that is continuous with the slider part 54 to be hidden within the sliding door 12 and harder to be exposed between the sliding door 12 and the vehicle body 10. Also, in the closed state, the wire harness routing structure 20 is easily applicable even when the space between the vehicle body 10 and the sliding door 12 in which the free movement section 35 of the wire harness 30 can be placed is small. Here, the connection portion between the free movement section 35 of the wire harness 30 and the vehicle body-side section 33 may be placed inside the weather strip 16. In this case, if the weather strip 16 is arranged to doubly enclose the door trim 14, the space between the vehicle body 10 and the sliding door 12 in which the free movement section 35 can be placed in the closed state becomes smaller.

The second end 61A of the first opening/closing groove 59A is located below the first end 60A in the vertical direction, the end of the first stress absorption groove 62A opposite to the first end 60A is located below the first end 60A in the vertical direction, and the biasing part 64 biases the first slider part 54A upward in the vertical direction. With this, the biasing part 64 easily biases the first slider part 54A toward the first end 60 both when the first slider part 54A moves along the first opening/closing groove 59A and when the first slider part 54A moves along the first stress absorption groove 62A. In addition, as a result of the first slider part 54A being biased toward the first end 60A during the opening and closing of the sliding door 12, the free movement section 35 is prevented from becoming slack.

There are two sets of the slider part 54 and the guide groove 58, namely, a set of the first slider part 54A and the first guide groove 58A and a set of the second slider part 54B and the second guide groove 58B. This allows the door-side section 34 to be guided more smoothly by the opening and closing of the sliding door 12, thereby also allowing the free movement section 35 continuous with the door-side section 34 to change its posture more smoothly.

Also, the first stress absorption groove 62A and the second stress absorption groove 62B are provided so as to extend along one straight line. This allows the door-side section 34 to be smoothly guided when a tread load F is applied to the exposed section 36.

Also, the first opening/closing groove 59A is shorter than the second opening/closing groove 59B. With this, the sliding door 12 does not need a large space for the guide component 56.

The door support component 40 includes a slider holding part that connects the first slider part 54A and the second slider part 54B and maintains a constant distance between the first slider part 54A and the second slider part 54B. This allows the first slider part 54A and the second slider part 54B to move along the respective guide grooves 58 while maintaining a constant distance therebetween.

The slider holding part covers and protects the door-side section 34 from the portion where the first slider part 54A is provided to the portion where the second slider part 54B is provided. With this, the slider holding part can be used as a protector.

In addition, due to the fact that the corrugated tube 32 is externally mounted on the free movement section 35, a tread load F on the free movement section 35 is transmitted to the wire harness 30 via the corrugated tube 32. In this case, the wire harness 30 can move freely in the extending direction with respect to the corrugated tube 32 and the protector, making it possible for the wire harness 30 to follow the stretch deformation of the corrugated tube 32. Accordingly, it is possible to prevent an increase in tension on the wire harness 30 even when a tread load F is applied to the free movement section 35.

Also, one end of the corrugated tube 32 is supported on the bearing-side protector 46 via the shaft-side protector 41 so as to be rotatable about the central axis CA. When the corrugated tube 32 changes its posture due to the opening and closing of the sliding door 12, the corrugated tube 32 can be subjected to a torque around the central axis CA. Even in this case, the torque applied to the corrugated tube 32 can be absorbed by the rotation of the corrugated tube 32 about the central axis CA with respect to the protector.

### Additional Notes of Embodiment 1

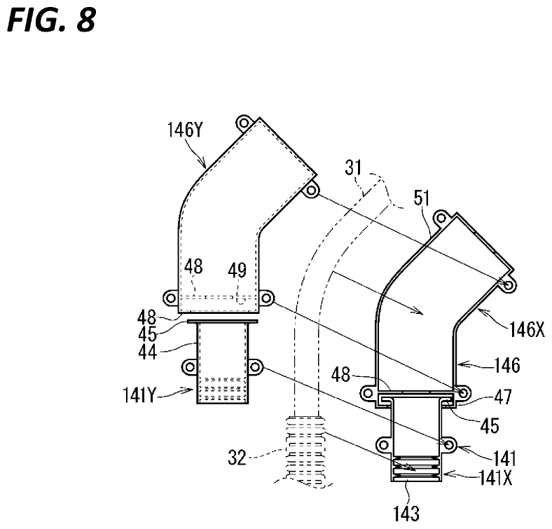

FIG. 8 is a diagram showing a modification of the shaft-side protector 41 and the bearing-side protector 46.

A shaft-side protector 141 according to the modification is a component into which a first split component 141X and a second split component 141Y, which have a shape obtained by splitting the portion of the shaft-side protector 141 through which the wire harness 30 passes along the axial direction, are combined. Similarly, the bearing-side protector 146 according to the modification is a component into which a first split component 146X and a second split component 146Y, which have a shape obtained by splitting the portion of the bearing-side protector 146 through which the wire harness 30 passes along the axial direction, are combined. This facilitates the retrofitting of the shaft-side protector 141 and the bearing-side protector 146 to the wire harness 30 and the corrugated tube 32. The first split components 141X and 146X and the second split components 141Y and 146Y may each be a split in half or in any other proportion.

The portions of the split components 146X and 146Y of the bearing-side protector 146 that serve as the bearing part 47 each have a rib. A recess is formed in the rib. The ribs and recesses of the two split components 146X and 146Y are combined to form the above-described confining walls 48 and insertion hole 50. Here, the protective part 51 of the bearing-side protector 146 extends from the outer edges of the ribs, rather than from the circumferential edges of the recesses of the ribs. The portion of the wiring member 31 that extends out of the shaft-side protector 141 is held by the circumferential edge of the insertion hole 50 when the shaft-side protector 141 rotates.

A fixing part between the first split component 141X, 146X and the second split component 141Y, 146Y is a screw or the like. The fixing part between the first split component 141X, 146X and the second split component 141Y, 146Y is rigid such that the cylindrical shapes of the shaft part 44 and the bearing part 47 do not collapse even when a torque or the like of the corrugated tube 32 is applied.

In this modification, a tube holding part 143 of the shaft-side protector 141 covers the corrugated tube 32. With this, it is possible to mount the tube holding part 143 on the outer circumference of the corrugated tube 32. The tube holding part 143 in the split components 141X and 141Y has protrusions that protrude inside the portion to serve as the tubular body 42. The protrusions of the two split components 141X and 141Y are combined to form an annular protrusion that fits to the outer side of the small-diameter tube sections.

In the bearing-side protector 146, the slider part 54 may not be split and may be provided in either the first split component 146X or the second split component 146Y. Alternatively, a split slider part 54 may be provided on each of the first split component 146X and the second split component 146Y.

Although the description has been given in which the slider part 54 is provided on the bearing-side protector 46, this is not an essential configuration. The slider part may be provided on the wire harness via a member different from the bearing-side protector 46.

Although the description has been given in which the door support component 40 includes the shaft-side protector 41 and the biasing part 64, this is not an essential configuration. The shaft-side protector 41 and the biasing part 64 may be omitted.

Although the description has been given in which two sets of a slider part 54 and a guide groove 58 are provided, this is not an essential configuration. Only one set of a slider part and a guide groove may be provided. Embodiment 2 below will describe an example in which only one set of a slider part and a guide groove is provided.

### Embodiment 2

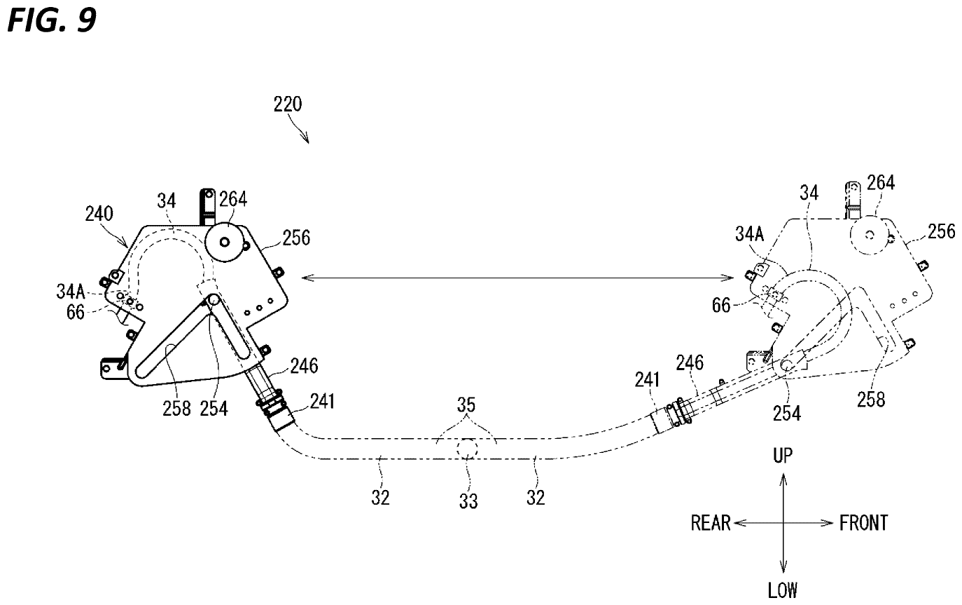

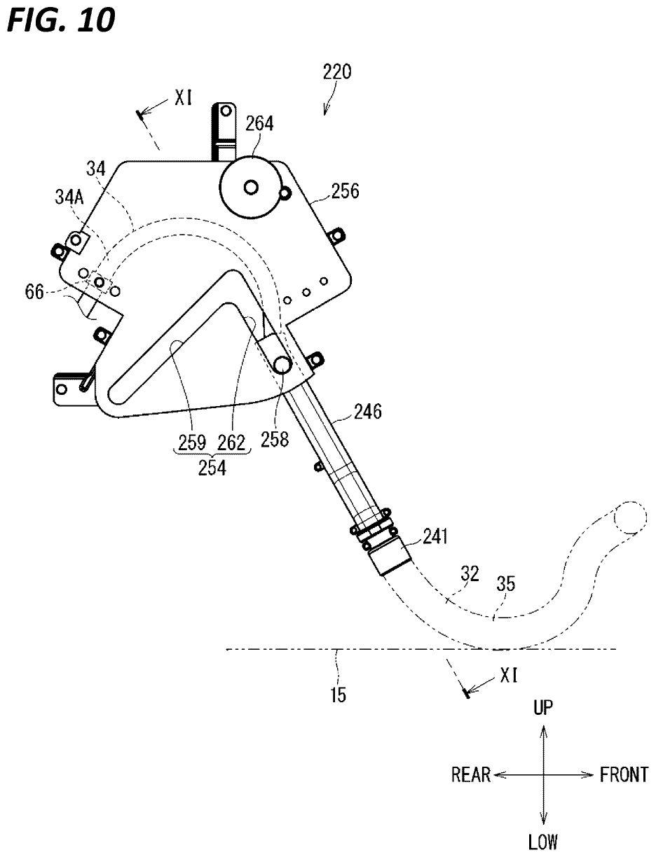

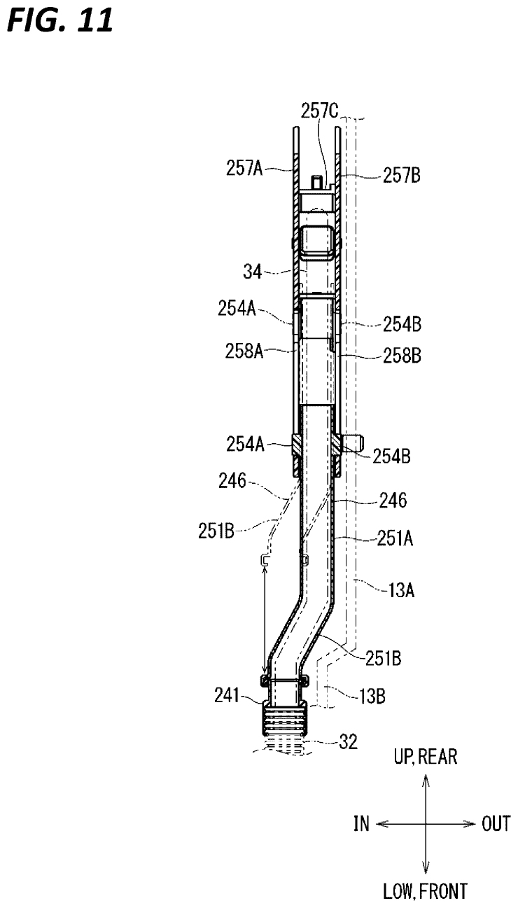

FIG. 9 is a schematic plan view showing a wire harness routing structure 220 according to Embodiment 2. Note that a door support component 240 indicated by solid lines in FIG. 9 is in the first open state, and the door support component 240 indicated by dashed two-dotted lines is in the closed state. FIG. 10 is a schematic front view showing the second open state. FIG. 11 is a cross-sectional view taken along a line XI-XI in FIG. 10. In the following description, the focus will be made on the parts that differ from those in Embodiment 1, the same reference numerals will be used for components similar to those in Embodiment 1, and the detailed description thereof may be omitted.

In the wire harness routing structure 220, the configuration of a door support component 240 differs from that of the above-described door support component 40. Specifically, the door support component 240 includes only one set of a slider part 254 and a guide groove 258 along the extending direction of the door-side section 34. The guide groove 258 here is a groove in which both an opening/closing groove 259 and a stress absorption groove 262 are continuous with each other. Here, only one guide groove 258 corresponding to the above-described first guide groove 58A is provided in a guide component 256. Except for the one guide groove 258, no groove for guiding the slider part 254 of the door-side section 34 is provided in the guide component 256. The slider part 254 that is guided in the guide groove 258 is provided only at one position along the extending direction of the door-side section 34.

As shown in FIG. 11, this slider part 254 has an inner slider part 254A and an outer slider part 254B that protrude from the same position along the extending direction of the door-side section 34 to opposite sides of each other along the inside and outside direction of the vehicle. The guide component 256 includes an inner guide plate 257A provided on the vehicle interior side relative to the door-side section 34 and an outer guide plate 257B provided on the vehicle exterior side relative to the door-side section 34. The guide grooves 258 include an inner guide groove 258A that is formed in the inner guide plate 257A and into which the inner slider part 254A is fitted and an outer guide groove 258B that is formed in the outer guide plate 257B and into which the outer slider part 254B is fitted. The inner guide groove 258A and the outer guide groove 258B correspond to the inner slider part 254A and the outer slider part 254B provided at the same position along the extending direction of the door-side section 34. Thus, in this case, although there are two sets of a slider part 254 and a guide groove 258 in the inside-outside direction of the vehicle, it can be regarded that only one set is provided in the extending direction of the door-side section 34.

The guide component 256 includes a connection plate 257C. The connection plate 257C connects the inner guide plate 257A and the outer guide plate 257B. The inner guide plate 257A and the outer guide plate 257B are held at a fixed distance along the inside-outside direction of the vehicle by being connected by the connection plate 257C.

Also in this example, the door support component 240 includes a shaft-side protector 241 and a bearing-side protector 246. The inner slider part 254A and the outer slider part 254B are provided on the protector 246. The inner slider part 254A protrudes from the inside-facing surface of the protector 246 and the outer slider part 254B protrudes from the outside-facing surface.

Each of the inner slider part 254A and outer slider part 254B is not provided with a recess that fits into the peripheral edge of the corresponding guide groove 258 of the guide plates 257A and 257B. The sides of the inner slider part 254A and the outer slider part 254B are formed in the shape of a cylindrical sides or conical sides. Even in this case, the inner slider part 254A is fitted into the inner guide groove 258A and the outer slider part 254B is fitted into the outer guide groove 258B, thereby preventing the inner slider part 254A and the outer slider part 254B from disengaging from the corresponding guide grooves 258A and 258B.

In the wire harness routing structure 220, no slider part 254 other than the slider part 254 that is fitted into the guide groove 258 is provided along the extending direction of the door-side section 34. In the wire harness routing structure 220, a second slider part other than the slider part 254 may be provided. In this case, the guide component 256 may or may not be provided with a groove in which the second slider part is fitted. However, if the guide component 256 is provided with a groove into which the second slider part is fitted, such a groove may be configured not to have both the opening/closing groove 259 and the stress absorption groove 262. Such a groove may also be configured to guide only one of the state change between the closed state and the first open state and the state change between the first open state and the second open state. Such a groove may also be configured to have only one of the opening/closing groove 259 and the stress absorption groove 262, for example.

The slider part 254 is located at the upper end of the protector 246. The lower end of the protector 246 is a free end. The protector 246 is rotatably supported on the guide component 256 with the slider part 254 at the upper end serving as the axis of rotation. The protector 246 rotates as a result of the lower end being pulled by the wire harness 30 when the sliding door 12 is opened or closed, for example.

Also, in this example, the door support component 240 includes a biasing part 264. The biasing part 264 biases the slider part 254 in the same manner as the above-described biasing part 64. The biasing part 264 and the slider part 254 are connected to each other by a not-shown connection portion.

The sliding door 12 includes a door body 13A and an overhang 13B that overhangs from the lower portion of the door body 13A to the interior of the vehicle. For example, the door body 13A and the overhang 13B are different portions of the door panel 13. The guide component 256 is located above the overhang 13B and is mounted on the door body 13A. The protector 246 includes a first protective part 251A covering the portion of the door-side section 34 where the slider part 254 is provided, and a second protective part 251B extending from the first protective part 251A to the bottom and interior of the vehicle. The second protective part 251B covers the section on the vehicle body-side connector 37 side relative to the first protective part 251A.

As shown in FIG. 11, the second protective part 251B offsets the upper and lower ends of the protector 246 in the inside-outside direction of the vehicle. For example, the second protective part 251B may extend outside the guide component 256 in the first open state. Also, for example, the overhang 13B may be located at a height smaller than the second protective part 251B in the first open state. With this, the portion of the wire harness 30 that extends out of the protector 246 can pass through the inside of the vehicle relative to the overhang 13B in the first open state, thereby preventing this portion from coming into contact with the overhang 13B. For example, the overhang 13B may also be located at the same height as the second protective part 251B in the second open state. With this, the protector 246 can pass through the inside of the vehicle relative to the overhang 13B in the second open state, thereby preventing the protector 246 from coming into contact with the overhang 13B.

In the example shown in FIG. 9, the door-side section 34 has a supported portion 34A on the door-side connector 38 side relative to the location where the slider part 254 is provided. The supported portion 34A is supported by the guide component 256. As the slider part 254 moves along the guide groove 258 and the protector 246 rotates with the slider part 254 serving as the axis of rotation, the door-side section 34 deforms between the portion where the slider part 254 is provided and the supported portion 34A. The supported portion 34A may be supported on the guide component 256 so as to be rotatable about an axis along the inside-outside direction of the vehicle. The door support component 240 may have a rotating support component 66 that holds the supported portion 34A and is rotatably supported by the guide component 256.

### <Effects>

The wire harness routing structure 220 can also achieve the same effects as the above-described wire harness routing structure 20, except for the effect brought by the plurality of guide grooves 58 including the opening/closing groove 59 and the stress absorption groove 62 being provided in the guide component 56.

According to the wire harness routing structure 220, the guide component 256 includes only one guide groove 258 into which the slider part 254 is fitted and that has the opening/closing groove 259 and the stress absorption groove 262, so that it is possible to reduce the size of the guide component 256 in the direction along the main surface of the sliding door 12, compared to the case of Embodiment 1 in which the guide component 56 has the plurality of guide grooves 58 including the opening/closing groove 59 and the stress absorption groove 62.

Since the slider part 254A, 254B and the guide groove 258A, 258B are provided on each of the sides in the inside-outside direction of the vehicle, it is easier to prevent the slider parts 254A and 254B from disengaging from the guide grooves 258A and 258B. It is also easier to realize the inner slider part 254A and the outer slider part 254B in a simple shape. For example, the inner slider part 254A does not have a recess into which the peripheral edge of the inner guide groove 258A in the inner guide plate 257A fits. Similarly, the outer slider part 254B does not have a recess into which the peripheral edge of the outer guide groove 258B in the outer guide plate 257B fits.

Also, there is no slider part other than the slider part 254 that is fitted into the guide groove 258 along the extending direction of the door-side section 34. With this, it is possible to reduce the complexity in the structure of the door support component 240.

Also, the slider part 254 is provided at the upper end of the protector 246, and the lower end of the protector 246 is a free end. This can reduce the size of the door support component 240 compared to the door support component 40 in which the slider parts 54 are respectively provided at the upper end and the lower end of the protector 41.

Also, the sliding door 12 includes the overhang 13B, the guide component 256 is located above the overhang 13B, and the protector 246 has the first protective part 251A and the second protective part 251B. With this, while the guide component 256 is fitted above the overhang 13B of the sliding door 12, the lower portion of the door-side section 34 is prevented by the second protective part 251B from coming into contact with the overhang 13B.

### Additional Notes of Embodiment 2

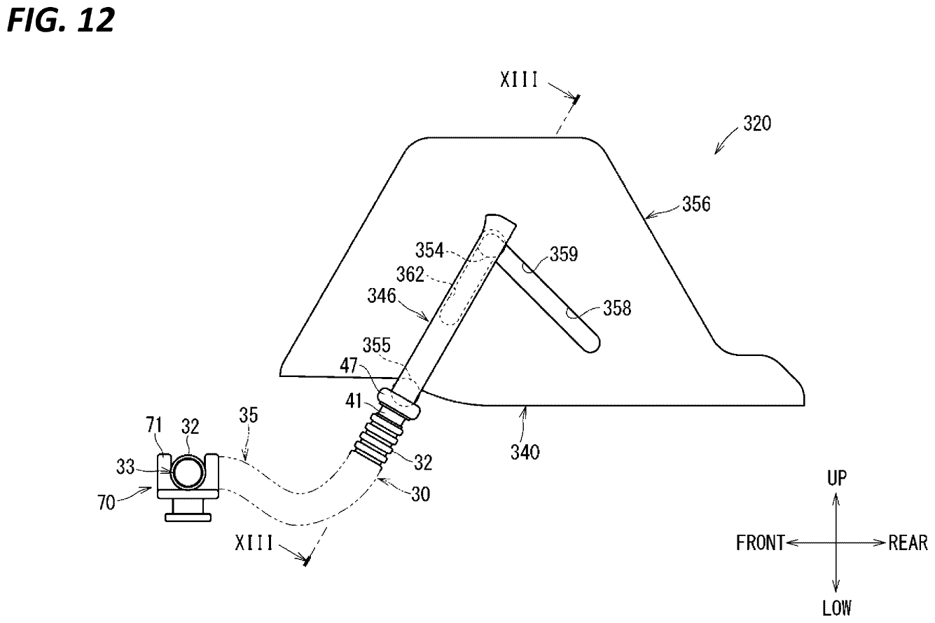

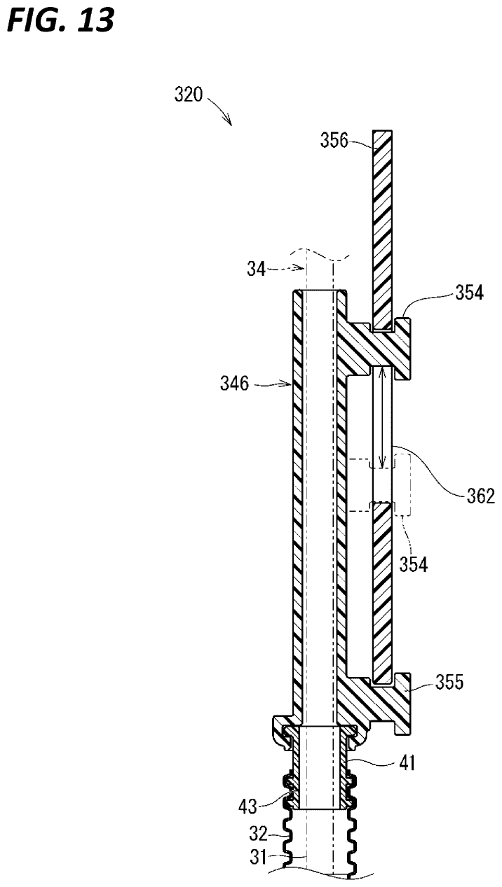

FIG. 12 is a schematic plan view showing a modification of the wire harness routing structure 20. FIG. 13 is a cross-sectional view taken along a line XIII-XIII in FIG. 12.

In a wire harness routing structure 320 shown in FIG. 12, there is also only one set of a guide groove 358 including an opening/closing groove 359 and a stress absorption groove 362, and a slider part 354 that is fitted into the guide groove 358. The wire harness routing structure 320 includes, in addition to the slider part 354, a slider part 355 that does not fit into the guide groove.

Specifically, a door support component 340 of the wire harness routing structure 320 includes a lower slider part 355 provided below a slider part 354 along the extending direction of the door-side section 34. A guide component 356 does not include a groove into which the lower slider part 355 fits. The lower slider part 355 is guided along the lower edge of the guide component 356 between the first open state and the closed state. The lower edge of the guide component 356 has a shape that corresponds to, for example, the upper peripheral edge of the above-described second guide groove 58B. This allows the wire harness 30 to be guided between the first open state and the closed state by the set of the lower slider part 355 and the lower edge of the guide component 356, in addition to the set of the slider part 354 and the guide groove 358. Due to the absence of a guide groove corresponding to the lower slider part 355, it is possible to reduce the size of the guide component 356. The configuration in which the lower slider part 355 is guided along the lower edge of the guide component 356 may be applied to the guide component 256 of the above-described wire harness routing structure 220.

The present disclosure can be regarded as a wire harness routing structure in which the slider part 254 moves along the groove of the guide component 256 when the sliding door changes between the open state and the closed state, and only one set of a slider part 254 and a groove is provided along the extending direction of the door-side section. According to this configuration, it is possible to reduce the size of the guide component 256 in the direction along the main surface of the sliding door.

Note that the configurations of the above-described embodiments and modifications can be freely combined unless they contradict each other.

### LIST OF REFERENCE NUMERALS

10 Vehicle body
11 Entry/exit opening
12 Sliding door
13 Door panel
13A Door body
13B Overhang
14 Door trim
15 Support arm
16 Weather strip
20, 220, 320 Routing structure
30 Wire harness
31 Wiring member
32 Corrugated tube
33 Vehicle body-side section
34 Door-side section
34A Supported portion
35 Free movement section
36 Exposed section
37 Vehicle body-side connector
38 Door-side connector
40, 240, 340 Door support component
41, 141, 241 Shaft-side protector
42 Tubular body
43 Tube holding part
44 Shaft part
45 Flange
46, 146, 246, 346 Bearing-side protector
47 Bearing part
48 Confining wall
49 Annular recess
50 Insertion hole
51 Protective part
52 Protective wall (slider holding part)
54, 254, 354 Slider part
54A First slider part
54B Second slider part
56, 256, 356 Guide component
57 Guide body
58, 258, 358 Guide groove
58A First guide groove
58B Second guide groove
59, 259 Opening/closing groove
59A First opening/closing groove
59B Second opening/closing groove
59B1 Curved portion
59B2 Straight portion
60, 60A, 60B First end
61, 61A, 61B Second end
62, 262 Stress absorption groove
62A First stress absorption groove
62B Second stress absorption groove
64, 264 Biasing part
65 Biasing part support part
66 Rotating support component
70 Vehicle body support component
71 Tube holding part
141X, 146X First split component
141Y, 146Y Second split component
251A First protective part
251B Second protective part
257A Inner guide plate
257B Outer guide plate
257C Connection plate
258A Inner guide groove
258B Outer guide groove
355 Lower slider part
F Tread load
CA Central axis

1. A wire harness routing structure that connects a device provided in a vehicle body and a device provided in a sliding door, the wire harness routing structure comprising:
a wire harness that includes a vehicle body-side section supported on the vehicle body, a door-side section supported on the sliding door, and a free movement section located between the vehicle body-side section and the door-side section; and
a door support component that supports the door-side section on the sliding door,
wherein the free movement section includes an exposed section configured to be exposed between the vehicle body and the sliding door when the sliding door is open,
the door support component includes a slider part provided in the door-side section and a guide component in which a guide groove for guiding the slider part is formed,
the guide groove includes an opening/closing groove having a first end and a second end, and a stress absorption groove extending from the first end in a direction that intersects with an extending direction of the opening/closing groove, and
when a state where the sliding door is closed is defined as a closed state, a state where the sliding door is open and no tread load is applied to the exposed section is defined as a first open state, and a state where the sliding door is open and a tread load is applied to the exposed section is defined as a second open state,
the slider part is located at the first end of the opening/closing groove in the first open state,
the opening/closing groove is formed so that the slider part moves along the opening/closing groove from the first end toward the second end during a change from the first open state to the closed state, and
the stress absorption groove is formed so that the slider part moves along the stress absorption groove during a change from the first open state to the second open state.

2. The wire harness routing structure according to claim 1,
wherein the door support component includes a biasing part configured to bias the slider part toward the opening/closing groove along an extending direction of the stress absorption groove.

3. The wire harness routing structure according to claim 2, further comprising:
a vehicle body support component that supports the vehicle body-side section on the vehicle body at a position of the vehicle body-side section that is adjacent to the free movement section,
wherein the biasing part biases the slider part toward the first end along the extending direction of the opening/closing groove, and
the first end is further away from the vehicle body support component than the second end in the closed state.

4. The wire harness routing structure according to claim 3,
wherein the second end of the opening/closing groove is located at a position lower than the first end in a vertical direction,
an end of the stress absorption groove that is opposite to the first end is located at a position lower than the first end in the vertical direction, and
the biasing part biases the slider part upward along the vertical direction.

5. The wire harness routing structure according to claim 1,
wherein there is only one set of the slider part and the guide groove along an extending direction of the door-side section.

6. The wire harness routing structure according to claim 5,
wherein the slider part includes an inner slider part and an outer slider part that protrude from the same position along the extending direction of the door-side section to opposite sides of each other along an inside-outside direction of a vehicle,
the guide component includes an inner guide plate provided on an interior side of the vehicle relative to the door-side section and an outer guide plate provided on an exterior side of the vehicle relative to the door-side section, and
the guide groove includes an inner guide groove that is formed in the inner guide plate and into which the inner slider part is fitted, and an outer guide groove that is formed in the outer guide plate and into which the outer slider part is fitted.

7. The wire harness routing structure according to claim 5,
wherein, other than the slider part, there is no slider part along the extending direction of the door-side section.

8. The wire harness routing structure according to claim 5,
wherein the door support component includes a lower slider part provided below the slider part along the extending direction of the door-side section, and
the lower slider part is guided along the lower edge of the guide component between the first open state and the closed state.

9. The wire harness routing structure according to claim 1,
wherein the door support component includes a protector that covers and protects the door-side section,
the slider part is provided at an upper end of the protector, and
a lower end of the protector is a free end.

10. The wire harness routing structure according to claim 1,
wherein the slider part includes a first slider part and a second slider part provided at positions distanced from each other along an extending direction of the door-side section,
the guide groove includes a first guide groove configured to guide the first slider part and a second guide groove configured to guide the second slider part,
the first guide groove includes a first opening/closing groove serving as the opening/closing groove and a first stress absorption groove serving as the stress absorption groove, and
the second guide groove includes a second opening/closing groove serving as the opening/closing groove and a second stress absorption groove serving as the stress absorption groove.

11. The wire harness routing structure according to claim 10,
wherein the first stress absorption groove and the second stress absorption groove extend along one straight line.

12. The wire harness routing structure according to claim 10,
wherein the first opening/closing groove is shorter than the second opening/closing groove.

13. The wire harness routing structure according to claim 10,
wherein the door support component includes a slider holding part that connects the first slider part and the second slider part to keep a distance between the first slider part and the second slider part constant.

14. The wire harness routing structure according to claim 13,
wherein the slider holding part covers and protects the door-side section from a portion where the first slider part is provided to a portion where the second slider part is provided.

15. The wire harness routing structure according to claim 1,
wherein the sliding door includes a door body and an overhang that overhangs from a lower portion of the door body toward an interior side of a vehicle,
the guide component is located above the overhang and is mounted on the door body,
the door support component includes a protector that covers and protects the door-side section, and
the protector includes a first protective part that covers a portion of the door-side section where the slider part is provided, and a second protective part that extends from the first protective part to a lower and interior side of the vehicle.

16. The wire harness routing structure according to claim 1,
wherein the wire harness includes a wiring member and a corrugated tube that is externally fitted to the wiring member, and
the wiring member is inserted into the corrugated tube so as to be freely movable along an extending direction of the corrugated tube.

17. The wire harness routing structure according to claim 16,
wherein the door support component includes a protector that covers and protects a portion of the door-side section where the slider part is provided, and
an end of the corrugated tube is supported on the protector so as to be rotatable about a central axis.

18. A wire harness routing structure that connects a device provided in a vehicle body and a device provided in a sliding door, the wire harness routing structure comprising:
a wire harness that includes a vehicle body-side section supported on the vehicle body, a door-side section supported on the sliding door, and a free movement section located between the vehicle body-side section and the door-side section; and
a door support component that supports the door-side section on the sliding door,
wherein the free movement section includes an exposed section configured to be exposed between the vehicle body and the sliding door when the sliding door is open,
the door support component includes a slider part provided in the door-side section and a guide component in which a groove for guiding the slider part is formed,
when a state where the sliding door is closed is defined as a closed state, and a state where the sliding door is open is defined as an open state,
the slider part moves along the groove during a state change between the open state and the closed state, and
there is only one set of the slider part and the groove along an extending direction of the door-side section.

19. A door support component for a wire harness that includes: a vehicle body-side section supported on a vehicle body, a door-side section supported on a sliding door, and a free movement section located between the vehicle body-side section and the door-side section, the door support component supporting the door-side section on the sliding door and comprising:
a slider part provided in the door-side section; and
a guide component in which a guide groove for guiding the slider part is formed,
wherein the guide groove includes an opening/closing groove having a first end and a second end, and a stress absorption groove extending from the first end in a direction that intersects with an extending direction of the opening/closing groove,
the free movement section includes an exposed section configured to be exposed between the vehicle body and the sliding door when the sliding door is open, and when a state where the sliding door is closed is defined as a closed state, a state where the sliding door is open and no tread load is applied to the exposed section is defined as a first open state, and a state where the sliding door is open and a tread load is applied to the exposed section is defined as a second open state,
the first end of the opening/closing groove is located at a position where the slider part is located in the first open state, and
the opening/closing groove is formed so that the slider part moves along the opening/closing groove from the first end toward the second end during a change from the first open state to the closed state, and
the stress absorption groove is formed so that the slider part moves along the stress absorption groove during a change from the first open state to the second open state.
